(19) United States
(12) Patent Application Publication
(10) Pub. No.: US 2002/0097446 A1
(43) Pub. Date: Jul. 25, 2002

(54) Apparatus and method for dark calibration of a linear CMOS sensor

(75) Inventor: Chen-Ho Lee, Hsin-Chu City (TW)

Correspondence Address: LOWE HAUPTMAN GILMAN & BERNER, LLP, Suite 310, 1700 Diagonal Road, Alexandria, VA, 22314, US

(73) Assignee: UMAX DATA SYSTEMS INC.

(21) Appl. No.: 09/768,281

(22) Filed: Jan. 25, 2001

(51) Int. Cl. H04N 1/00

(52) U.S. Cl. 358/406

(57) ABSTRACT

An apparatus in a linear complementary metal-oxide-semiconductor sensor for dark calibration comprises a plurality of exposure control devices used for controlling corresponding a first electrical access to a photocell and located between the corresponding photocell and in common a voltage line. In the present invention, the exposure control devices comprise on/off switches that can enable and disable the first electrical accesses. The apparatus is applied with a method for dark calibration of a scanner with a linear sensor. The method comprises disabling a plurality of electrical connections between a plurality of corresponding photocells and in common a voltage line in said linear sensor, and thereafter exposing said photocells.

### BACKGROUND OF THE INVENTION

1. Field of the Invention

The invention relates to an apparatus and method for dark calibration, and particularly relates to exposure control devices built in a linear sensor to implement dark calibration process.

2. Description of the Prior Art

Solid state image sensors are presently realized in two common forms: Charge Coupled Devices (CCDs) and MOS diode arrays. Both forms require specialized fabrication processes to suit them for image sensing and both forms also require substantial electronic circuits external to the sensing chip in order to drive the arrays and to process the output signal. A complete sensor subsystem therefore typically requires an assembly of many components with consequent implications of high production cost, power consumption and physical size.

Traditionally, solid state based scanners are realized charge-coupled devices (CCDs) as image capturing devices. Unfortunately, CCD technology is not compatible with standard DC processes for portable scanner development. In addition, CCDs use high voltage clock signals, implying correspondingly high power dissipation levels. Therefore, there is much interest in scanner using standard CMOS processes, which would promote integration and low power consumption.

Linear diode sensors are commonly based on a one dimensional row of photodiodes implemented as the reverse-biased semiconductor junctions of the type normally used to form the source and drain regions of MOS transistors. A high reverse bias is applied and the diode then is electrically isolated and exposed to light or other radiation to be detected. Incident radiation increases the reversed-bias leakage current to the diode and this current is effectively integrated on the reverse-bias capacitance of the isolated junction causing a reduction in the reverse-bias potential. The use of such techniques for conversion of radiation to electronic charge and potential is well known and practiced. In particular this technique is used in MOS linear diode type sensors. In these sensors a single MOS transistor controls access to the diode for the purpose of writing to the cell (that is, resetting to a high reverse-bias) and reading from it by connecting the diode to a bit-line (i.e. sense line) and thence ultimately to charge-sensing circuits which convert the charge stored within the cell to an output voltage.

Typically the linear, same as array, also can be accessed in scan-line format whereby the linear is read as consecutive pixels. This process is also commonly practiced and involves enabling a row of cells by a “word-line” which is connected in common to the access transistor gates of all cells in the row. Digital circuitry is used to generate and to drive the necessary pattern of word-line signals. Normally this circuitry may take the form of a shift register. As a word-line is enabled, the row of cells is connected to bit-lines and thereby to peripheral circuitry at the top of the linear. Further digital circuitry produces enabling signals that control analogue switching or sense circuitry to enable the signals on consecutive bit-lines to be connected to the output.

Shown in FIG. 1 is a column of an active sensor based on passive pixel cells 110. A passive pixel cell 110 has a very simple structure consisting of a photodiode PD with an associated capacitance Cd and a transistor switch MR. The photodiodes PD are connected to a common bus 120 through the switches MR1, MR2, . . . , MRx that are located inside each cell. The column bus 120 is coupled to the input of a charge amplifier (not shown), which provides a signal Vo that indicates the level of illumination collected by a one of the photodiodes PD.

However, a common problem of sensor arrays is spatial noise, which results form spatial variation between pixel cells in an array that are manifested itself as pattern noise in the image. Spatial noise is one of the major sources of degradation in image array performance. Spatial noise is often due to photo response non-uniformity, which results from the gain variations between photocells and column amplifiers when the photo sensors are illuminated. The magnitude of this form of spatial noise is signal-dependent. Another type of spatial noise is fixed pattern noise (FPN), which is a measure of the variations between pixels in an array when the photo sensors are in the dark. It is usually caused by mismatches between charge injections and clock feed-through in voltage drops at sensitive nodes as well as mismatches in dark currents.

There are two methods of conventional dark calibration for a scanner. FIG. 2 shows a flow chart of first type for dark calibration. First, it is necessary to turn off lamp for getting a background dark image (step 210). There is a disadvantage that external background may result in noise for the background dark image. Next the motion of scanning the background dark image is implemented (step 220) to get image data. Then some dark correction parameters need to be computed according to the background dark image (step 230). Then the lamp is turned on (step 240) prepared for scanning objective image. It is appreciated that it spends time to warm-up.

The flow chart of the second method is shown on FIG. 3. For dark compensation, it is necessary to first move image sensors to a black area of calibration chart (step 310) and thereafter scan the black area image (step 320). The dark correction parameters are computed for the dark compensation reference(step 330). However, high cost of precise calibration chart and long time for sensor-moving motion are main disadvantages for the second method of dark calibration.

### SUMMARY OF THE INVENTION

It is an object of the present invention to provide a method for dark calibration of a scanner. There are no on and off states of lamp for dark calibration and thereby eliminates external light noise and time for warm-up.

It is another object of the present invention to provide a method for dark calibration of a scanner without precise calibration chart. It spends less time and cost for the scanner to implement the process of dark calibration.

In the present invention, an apparatus in a linear complementary metal-oxide-semiconductor sensor for dark calibration comprises a plurality of exposure control devices used for controlling corresponding a first electrical access to a photocell and located between the corresponding photocell and in common a voltage line. The exposure control devices comprise on/off switches that can enable and disable the first electrical accesses. The apparatus is applied with a method for dark calibration of a scanner with a linear sensor. The method comprises disabling a plurality of electrical connections between a plurality of corresponding photocells and in common a voltage line in said linear sensor, and thereafter exposing said photocells.

### BRIEF DESCRIPTION OF THE DRAWINGS

A better understanding of the invention may be derived by reading the following detailed description with reference to the accompanying drawing wherein:

FIG. 1 is a schematic diagram of a passive photodiode-based cell structure that is employed in prior art active pixel sensors;

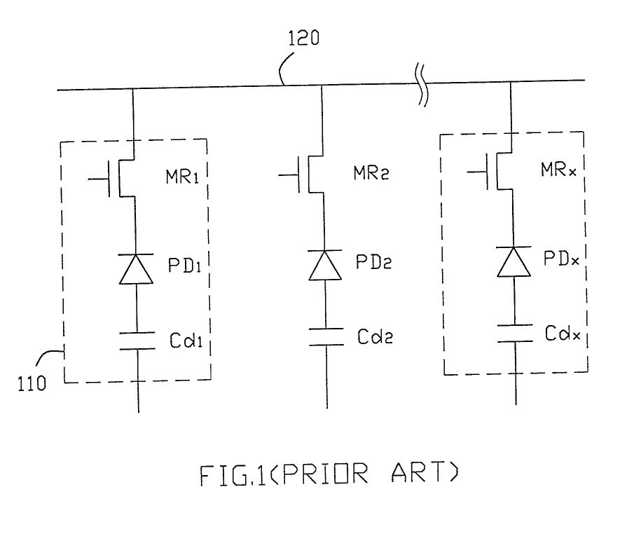

FIG. 2 is a flow chart illustrating a first conventional dark calibration for a scanner;

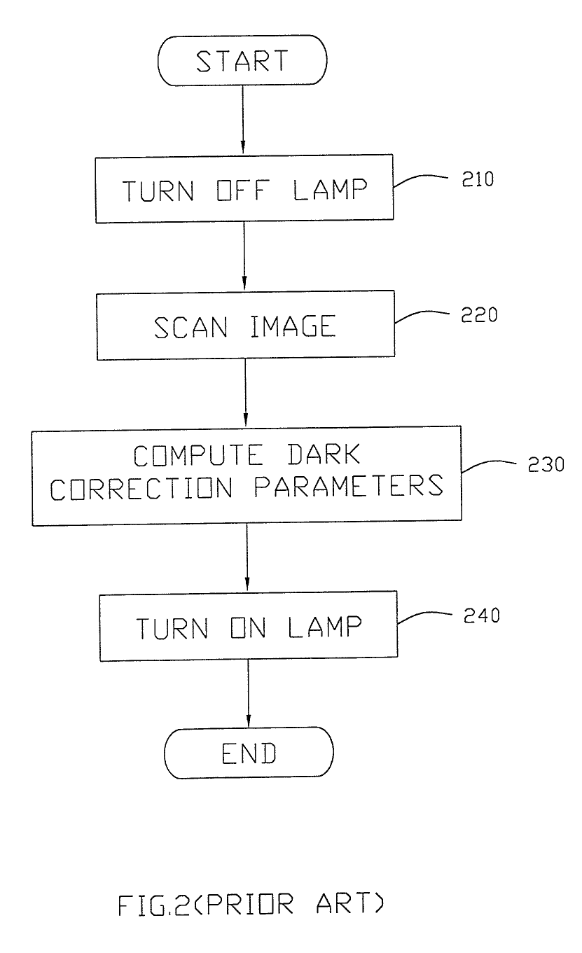

FIG. 3 is a flow chart illustrating a second conventional dark calibration for a scanner;

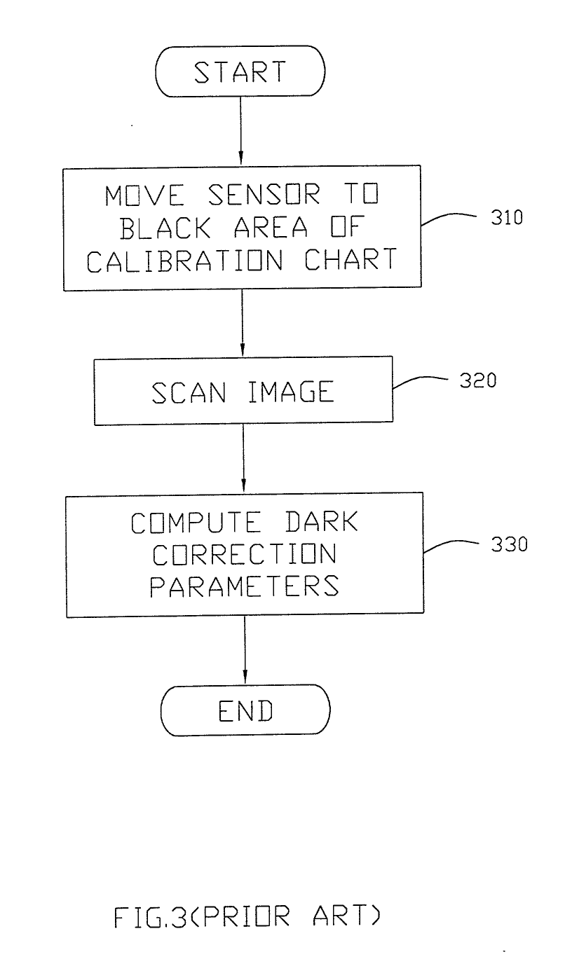

FIG. 4 is a flow chart illustrating a process of dark calibration of a scanner in accordance with the present invention; and

FIG. 5 is a schematic diagram of a photocell implemented in accordance with the present invention that can be employed in the pixel sensor of a scanner.

### DESCRIPTION OF THE PREFERRED EMBODIMENT

While the invention is described in terms of a single preferred embodiment, those skilled in the art will recognize that many devices described below can be altered as well as other substitutions with same function and can be freely made without departing from the spirit and scope of the invention.

Furthermore, there is shown a representative portion of a pixel sensor structure of the present invention in enlarged. The drawings are not necessarily to scale, as the thickness of the various layers are shown for clarify of illustration and should not be interpreted in a limiting sense. Accordingly, these regions will have dimensions, including length, width and depth, when fabricated in an actual device.

In the present invention, an apparatus in a linear complementary metal-oxide-semiconductor sensor of a scanner for dark calibration comprises a plurality of exposure control devices used for controlling a first electrical access to a photocell and located between the corresponding photocell and in common a voltage line. A plurality of read-out control devices between the photocells and a transferring bus in common; the read-out control devices are used for controlling a second electrical access from the photocells to the transferring bus. Furthermore, a plurality of reset control devices on bypasses that each is connected to an access between corresponding the photocell and the read-out device. A method for scanning images including a dark image by a scanner with a linear sensor comprises disabling a plurality of electrical connections between a plurality of corresponding photocells and in common a voltage line in the linear sensor. Then the photocells are exposed and reset by a plurality of bias voltage supports through a plurality of reset control modules. The data from the photocells is read-out to get dark image data. Next, dark calibration parameters are computed according to the dark image data, and then electrical connections are enabled. The disabling and enabling steps are implemented by the exposure control devices.

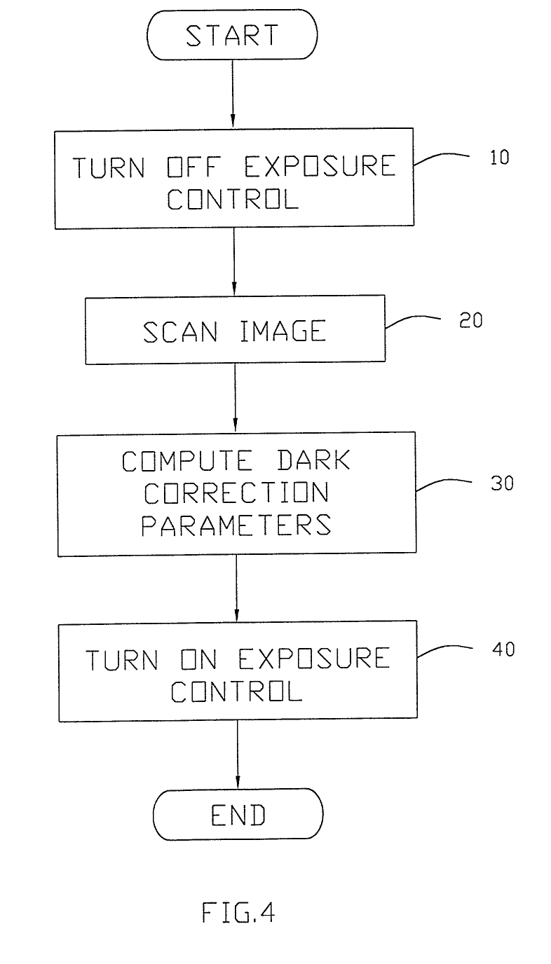

FIG. 4 is a flow chart illustrating dark calibration applied on a scanner in accordance with the present invention. First, there are exposure control devices in the photocells of the sensors. For getting dark calibration, the exposure control devices are turned off to block electrical access to photodiodes (step 10). The photodiodes are disabled and thereafter the scanning motion is implemented for dark image that in fact represents the bias of each pixel in a sensor (step 20). There is an advantage that each pixel of dark image can be used for doing compensation for each bias of the pixel in the sensor. Next, the dark correction parameters are computed according to the dark image (step 30). Then the exposure control devices are turned on for normal image scanning (step 40).

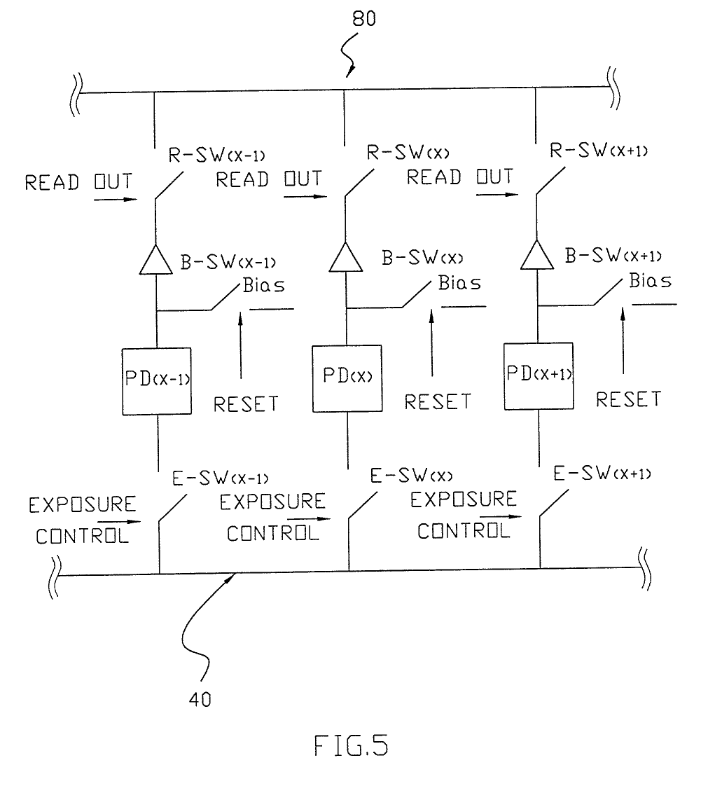

FIG. 5 is a schematic diagram of photocells implemented in accordance with the present invention that can be employed in the pixel sensor of a scanner. Each preferred photocell of linear sensor includes a photodiode PD, a read-out switch R-SW, a bias switch B-SW and a exposure control switch E-SW. All photodiodes PD(x−1), PD(x), PD(x+1) . . . , are in common connected to a bus 80 and coupled to a saturated voltage line 40. The read-out switches R-SW(x−1), R-SW(x), R-SW(x+1) . . . , are connected to corresponding external read-out circuit. The bias switch B-SW(x−1), B-SW(x), B-SW(x+1) . . . , are accesses to corresponding bias voltage supplies and external reset devices. In particular, the exposure control switches E-SW(x−1), E-SW(x), E-SW(x+1) . . . , control electrical connections between the saturated voltage line 40 and the photodiodes PD.

When the scanner executes the dark calibration process, the exposure control switches disable accesses to the photodiodes. The bias level corresponding to each photocell can be read as the dark image for each photocell and then used in computerization of dark calibration parameters. When the scanner executes a general image scanning, the exposure control switches just enable accesses to the photodiodes. Furthermore, though the switch devices are used as the exposure controls in the preferred embodiment, any control device that can control an electrical access to a photodiode may be used as the exposure control in the present invention. On the other hand, the photodiodes used in the preferred scanner also can be replaced for any similar devices.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. Apparatus in a linear complementary metal-oxide-semiconductor sensor for dark calibration comprising:
a plurality of exposure control devices, each said exposure control device used for controlling a first electrical access to a photocell and located between said corresponding photocell and in common a voltage line.

2. The apparatus of claim 1 further comprising:
a plurality of read-out control devices between said photocells and a transferring bus in common, said read-out control devices used for controlling a second electrical access from said photocells to said transferring bus; and
a plurality of reset control devices on a plurality of bypass, each said bypass connected to an access between corresponding said photocell and said read-out control device.

3. The apparatus of claim 2, wherein said read-out control device is coupled to a corresponding external circuit for purpose of reading-out.

4. The apparatus of claim 2, wherein said bypass is further connected a bias voltage supply circuit.

5. The apparatus of claim 1, wherein said exposure control device is coupled to an external circuit of exposure control.

6. The apparatus of claim 1, wherein said exposure control devices comprises a plurality of on/off switches.

7. The apparatus of claim 1, wherein said photocells comprises a plurality of photodiodes.

8. Apparatus in a linear complementary metal-oxide-semiconductor sensor of a scanner for dark calibration comprising:
a plurality of exposure control devices, each said exposure control device used for controlling a first electrical access to a photocell and located between said corresponding photocell and in common a voltage line;
a plurality of read-out control devices between said photocells and a transferring bus in common, said read-out control devices used for controlling a second electrical access from said photocells to said transferring bus; and
a plurality of reset control devices on a plurality of bypass, each said bypass connected to an access between corresponding said photocell and said read-out device.

9. The apparatus of claim 8, wherein each said read-out control device is coupled to corresponding external circuit for purpose of reading-out.

10. The apparatus of claim 8, wherein each said bypass is further connected a bias voltage supply circuit.

11. The apparatus of claim 8, wherein said exposure control device is coupled to an external circuit of exposure control.

12. The apparatus of claim 8, wherein each said exposure control device comprises an on/off switch.

13. The apparatus of claim 8, wherein each said photocell comprises a photodiode.

14. A method for dark calibration of a scanner with a linear sensor, said method comprising:
disabling a plurality of electrical connections between a plurality of corresponding photocells and in common a voltage line in said linear sensor; and
exposing said photocells.

15. The method according to claim 14 further comprising:
resetting said photocells by a plurality of bias voltage supports through a plurality of reset control modules;
reading out data from said photocells; and
computing a plurality of dark calibration parameters according to said data.

16. The method according to claim 14, wherein disabling step is implemented by a plurality of exposure control devices, and each said exposure control device is corresponding to each said photocell.

17. The method according to claim 16, wherein in said exposure control devices comprises a plurality of on/off switch devices for controlling said electrical connections.

18. The method according to claim 14, wherein in said exposure control devices further have ability to enable said electrical connections.

19. A method for scanning an image by a scanner with a linear sensor, said method comprising:
disabling a plurality of electrical connections between a plurality of corresponding photocells and in common a voltage line in said linear sensor;
exposing said photocells;
resetting said photocells by a plurality of bias voltage supports through a plurality of reset control modules;
reading out data from said photocells to get dark image data;
computing a plurality of dark calibration parameters according to said dark image data; and
enabling said electrical connections.

20. The method according to claim 19, wherein disabling and enabling steps are implemented by a plurality of on/off switches, and each said on/off switch is corresponding to each said photocell.
